(19) United States
(12) Patent Application Publication
(10) Pub. No.: US 2003/0107794 A1
(43) Pub. Date: Jun. 12, 2003

(54) Micro mirror array

(76) Inventors: James W. Siekkinen, Bay Village, OH (US); Xiaofeng Yang, Corvallis, OR (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/013,377

(22) Filed: Dec. 11, 2001

(51) Int. Cl. G02B 26/00

(52) U.S. Cl. 359/291; 359/290

(57) ABSTRACT

A micro mirror array including an upper wafer having a plurality of movable reflective surfaces located thereon and a lower wafer located below and coupled to the upper wafer. The lower wafer has an upper surface including a plurality of electrodes located thereon for controlling the movement of the movable reflective surfaces when a voltage is applied thereto. The lower wafer further includes control electronics generally spaced away from the upper surface and coupled to the electrodes for controlling the voltages applied to the electrodes.

### BACKGROUND OF THE INVENTION

The present invention is directed to a mirror array, and more particularly, to an array of individually movable mirrors for use in an optical cross connect engine.

In fiber optic communication systems a plurality of optical fibers are used to transmit light signals in a well known manner. In order to route the light signals to the desired destination, some fiber optic communication systems include a plurality of optical cross connect engines dispersed throughout the system. The optical cross connect engines function as “junction boxes” to route the light signals between various optical fibers in the desired manner. The optical cross connect engines typically include a plurality of mirrors and optical tools to route light signals between the various optical fibers. The mirror arrays typically are or include micro electro mechanical systems (“MEMS”) formed by conventional MEMS processing methods.

Most existing mirror arrays require a relatively large number of electrodes (i.e., typically two or four electrodes per mirror) to move the mirrors. The mirror arrays also typically require a relatively complex system of control electronics coupled to the electrodes to control and coordinate the voltages that are applied to the electrodes, which in turn controls movement of the mirrors.

In existing optical cross connect engine MEMS systems that include control electronics, the control electronic may be located on the same outer surface as the components to be controlled. In this case the control electronics and components to be controlled are located adjacent to each other on an outer surface of the wafer. However, the control electronics can be relatively bulky, and can therefore significantly increase the required surface area of the wafer. Furthermore, manufacturing a wafer including both the electrodes and the control electronics located on a common outer surface of a wafer can be complex and expensive.

Alternately, in many existing optical cross connect engine MEMS systems, the control electronics may be located on a first wafer and the components to be controlled may be located on a second wafer. The first wafer can then be located adjacent to the second wafer, and connections between the first and second wafer can be completed so that the control electronics can control the components to be controlled. However, in this case, the control electronics must be coupled to the electrodes by a large number of wire bond connections, and is therefore time consuming and expensive to assemble.

### SUMMARY OF THE INVENTION

In one embodiment, the present invention is a mirror array which includes an upper wafer which includes a plurality of movable reflective surface located thereon, and a lower wafer located below and coupled to the upper wafer. The lower wafer may include both the electrodes for controlling the movement of the movable reflective surfaces and the control electronics for controlling the voltages applied to the electrodes. In this manner, the electrodes, as well as the electronic components which control the electrodes, are integrated onto a single wafer.

In one embodiment, the invention is a mirror array including an upper wafer having a plurality of movable reflective surfaces located thereon and a lower wafer located below and coupled to the upper wafer. The lower wafer has an upper surface including a plurality of electrodes located thereon for controlling the movement of the movable reflective surfaces when a voltage is applied thereto. The lower wafer further includes control electronics located generally spaced away from the upper surface and coupled to the electrodes for controlling the voltages applied to the electrodes.

Other objects and advantages of the present invention will be apparent from the following description and the accompanying drawings.

### BRIEF DESCRIPTION OF THE DRAWINGS

FIG. 1 is a schematic representation of an optical cross connect engine;

FIG. 2 is a top plan view of a portion of one embodiment of the mirror array of the present invention;

FIG. 3 is a detail view of a portion of the mirror array of FIG. 2;

FIG. 4 is a top view of selected upper components of the array of FIG. 3;

FIG. 5 is a perspective exploded view of a portion of one embodiment of the mirror array of the present invention;

FIG. 6 is a representative cross section taken along line 6-6 of FIG. 3;

FIG. 7 is a representative cross section taken along line 7-7 of FIG. 3;

FIG. 8 is a schematic representation of a mirror of one embodiment of the mirror array of the present invention, illustrated in various rotational positions;

FIGS. 9-17 are a series of side cross sections illustrating a series of steps that may be used to form the mirror array of the present invention; and

FIGS. 18-26 are a series of side cross sections illustrating another series of steps that may be used to form the mirror array of the present invention.

### DETAILED DESCRIPTION

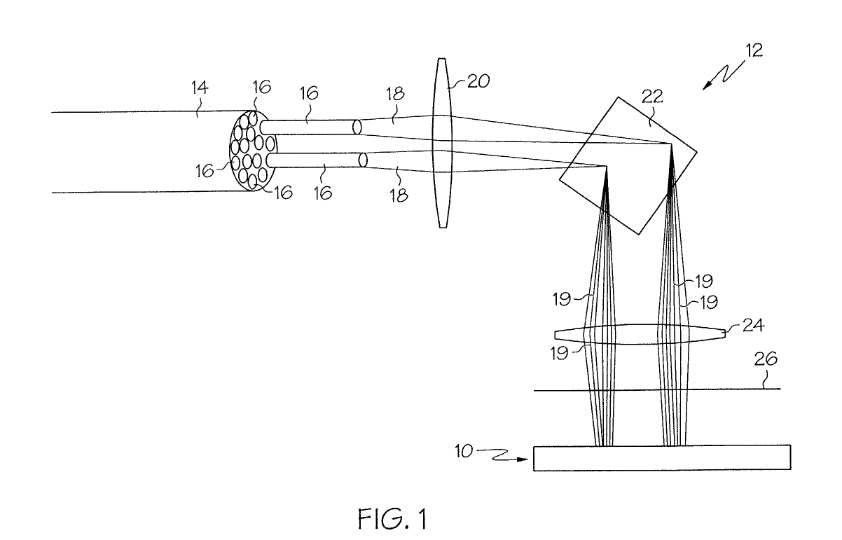

As shown in FIG. 1, the mirror array of the present invention, generally designated 10, can be used with or as part of an optical cross connect engine, generally designated 12. A plurality of fiber optic cables 14 (only one of which is shown in FIG. 1) may be coupled to the optical cross connect engine 12. Each fiber optic cable 14 may include a plurality of individual optical fibers 16 encased therein. Each optical fiber 16 may carry or transport a light signal or beam 18.

Each beam 18 from each optical fiber 16 that is coupled to the optical cross connect engine 12 may be passed through a lens 20 that focuses each beam 18 upon a diffraction grating lens system 22. The grating lens system 22 separates each beam 18 into a plurality of wavelength channel beams 19. Each wavelength channel beam 19 represents a discreet wavelength that carries a signal, and each beam 18 and fiber 16 can typically carry a large number of discreet wavelength channel beams or signals 19, up to 160 or more signals. The dispersed wavelength channel beams 19 may then be passed through a lens 24 and a quarter-wave plate 26 to compensate for the polarization sensitivity of the grating.

The wavelength channel beams 19 then reach the mirror array 10, also known as a micromechanical switching matrix. The mirror array 10 may include a plurality of movable mirrors or reflective surfaces such that the incoming signals 19 bounce off one of the mirrors in the desired direction. The reflected signals 19 are then passed back through the quarter-wave plate 26, lens 24, diffraction grating lens system 22 and lens 20, and are routed to the desired optical fiber 16 for further transportation. In this manner the mirror array 10 redirects light signals from a departure optic fiber to a destination optic fiber. The departure optic fiber may be the same as the destination optic fiber, or they may be different. Furthermore, the departure optic fiber may be in the same cable 14 as, or in a different cable from, the destination optic fiber. In other words, signals can be routed from any optic fiber connected to the cross connect engine to any optic fiber connected to the cross connect engine.

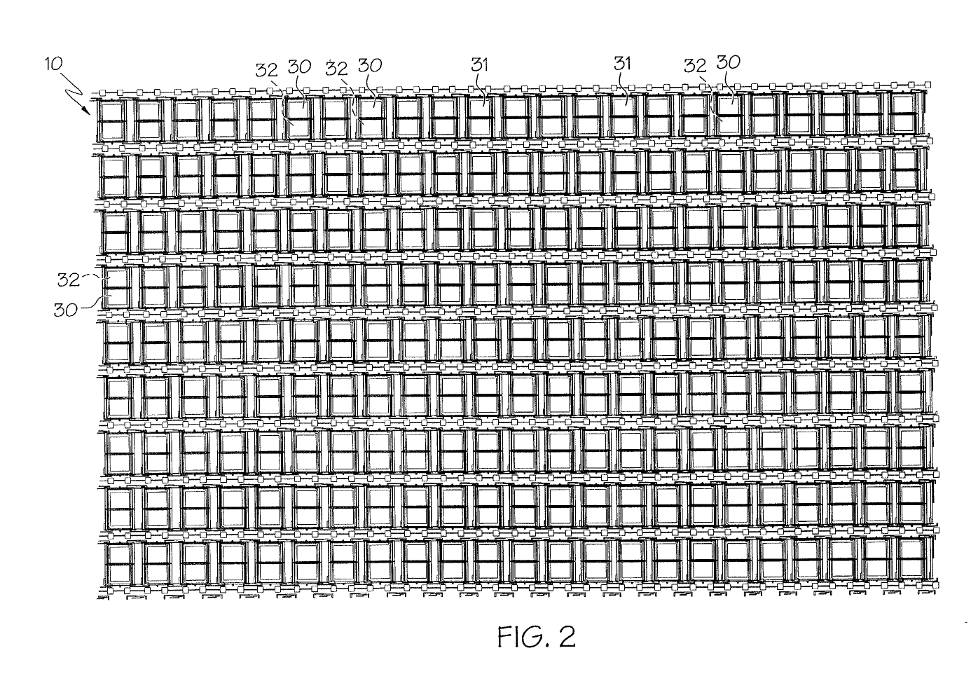

As best shown in FIG. 2, the mirror array 10 includes a plurality of movable mirrors 30 formed in an array, each mirror 30 including a reflective surface 31 located on an associated movable portion 32. The reflective surfaces 31 can be made from nearly any material that reflects the light signals to be transmitted (typically infrared light). The reflective surfaces 31 are preferably made of a metal, such as gold. Each of the mirrors 30 may be relatively small (i.e., in one embodiment on the order of about 20 microns×20 microns), and the array 10 can include nearly any desired number of mirrors 30 (i.e., in one embodiment about 500 mirrors). As noted earlier, each reflective surface 31 located on a movable portion 32, and each movable portion 32 can be rotated to move its associated reflective surface into the desired configuration to reflect light signals in the desired manner.

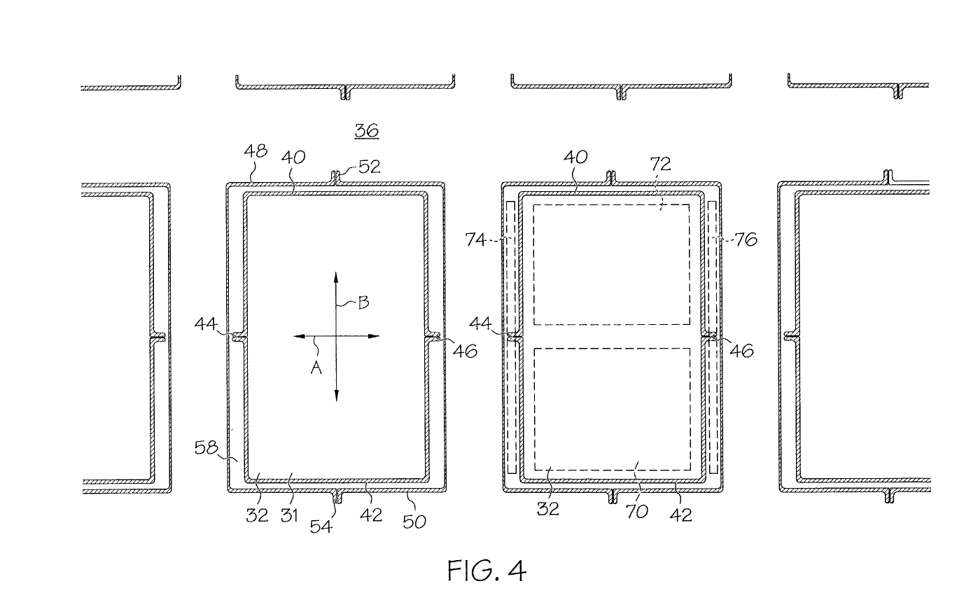

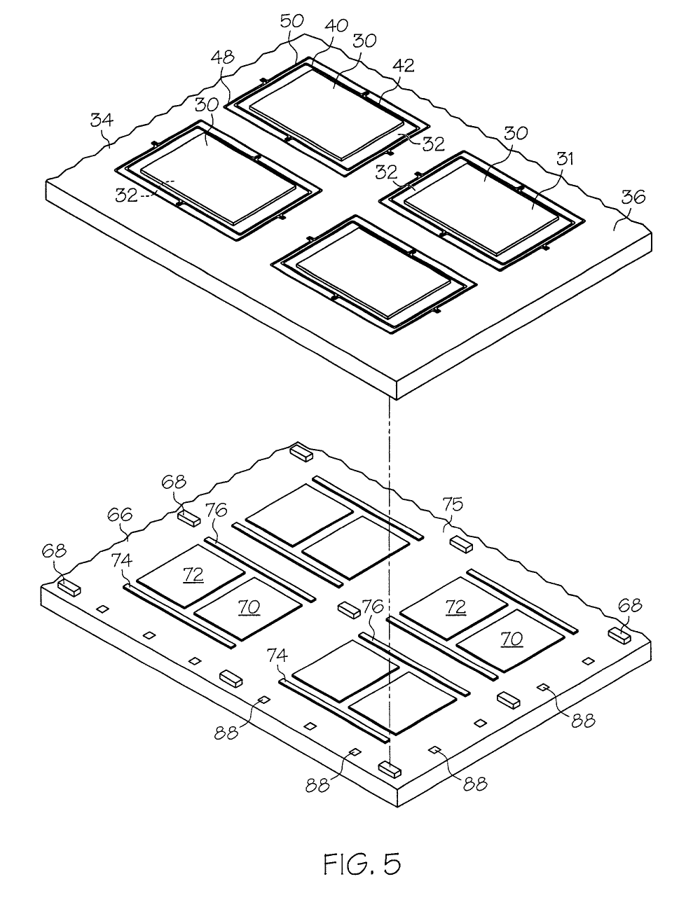

As shown in greater detail in FIGS. 5-7, the mirrors 30 are located on an upper wafer 34. The upper wafer 34 includes a base portion 36, and each of the movable portions 32 are movably coupled to the base portion 36. As best shown in FIG. 4, each movable portion 32 is defined by a set of cut outs or recesses 40, 42, 48, 50 formed in, and extending through the thickness of, the upper wafer 34. For example, the inner cut outs 40, 42 extend generally around the outer periphery of each movable portion 32. The inner cut outs 40, 42 are slightly spaced apart to define a pair of narrow inner arms 44, 46 located on opposite sides of the associated movable portion 32. In this manner, the portion of the upper wafer 34 located inside the inner cut outs 40, 42 is rotatable about an axis A defined by the inner arms 44, 46.

The upper wafer 34 also includes a set of outer cut outs 48, 50 that extend generally around the outer periphery of each movable portion 32 and are spaced apart to define a pair of outer arms 52, 54 located on opposite sides of the associated movable portion 32. Each movable portion 28 thus includes an intermediate surface 58 located between the inner 40, 42 and outer 48, 50 cut outs. In this manner, the portions of the upper wafer 34 located inside of the outer cut outs 48, 50 (including the intermediate surface 58) are rotatable about an axis B defined by the outer arms. Thus the inner 40, 42 and outer 48, 50, cut outs and inner 44, 46 and outer 52, 54 arms define the movable portions 32 that are double gimbaled, or independently pivotal about both axes A and B.

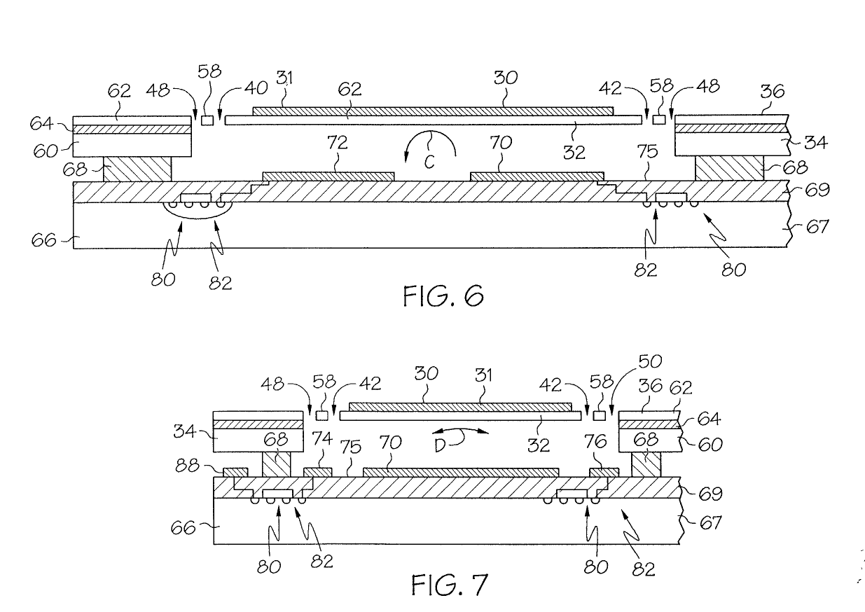

As best shown in FIGS. 6 and 7, the upper wafer 34 is preferably a silicon-on-insulator wafer which includes a lower silicon layer or support layer 60, an upper silicon layer 62, and an insulating layer 64 (such as silicon dioxide) located between the upper 60 and lower 62 silicon layers. However, the upper wafer 34 can be made from a wide variety of materials without departing from the scope of the present invention. More particularly, the upper wafer 34 can be made of nearly any material (preferably a machinable material) such that the desired movable portions 32 can be formed in the upper wafer 34. However, the movable portions 32 are preferably made of conductive material such that they can be moved by electrodes or electrical forces, as will be discussed in greater detail below. Thus, the layer of the upper wafer 34 from which the movable portions 32 are made (i.e. in this case the upper layer 62 of the upper wafer 34) is preferably made of a conductive material, or has a conductive material located thereon.

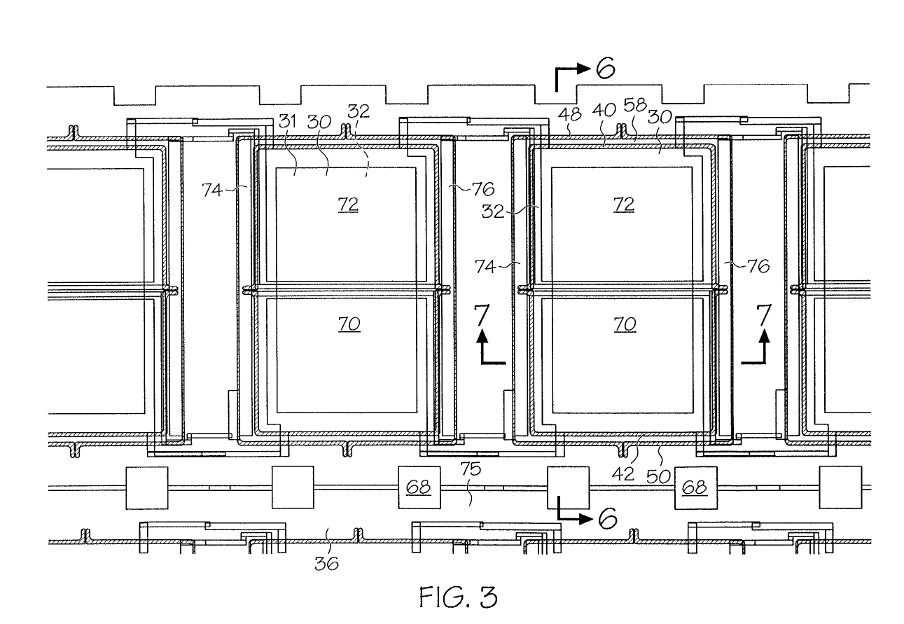

The upper wafer 34 is coupled to a lower wafer 66 that is located below the upper wafer 34. The upper wafer 34 can be coupled to the lower wafer 66 by a variety of methods, preferably eutectic bonding or glass frit bonding. As will be discussed in greater detail below, the bond between the upper 34 and lower 66 wafer is preferably a conductive bond. Eutectic bonding may be preferred because a eutectic bond requires relatively low bonding temperatures and can accommodate relatively high non-planarities between the surfaces to be bonded. For example, an eutectic bond may require a temperature of about 363° C. for a gold/silicon bond (i.e. a bond wherein one surface includes gold and the other silicon, and the gold diffuses into the silicon layer). Other solder bond systems (such as In/Sn; Sn/Pb; and Pb/Ag) may also be used, and these bonding systems typically require temperatures of about 250 to 350° C. Because temperatures much above 400° C. may damage certain components of the mirror array 10, it is desirable to use a bonding process which can be completed at temperatures below 400° C. As shown in FIGS. 3 and 5-7, the mirror array 10 may include a plurality of posts 68 that extend between the lower wafer 66 and upper wafer 34 and that consist of bonding materials. However, a wide variety of other structures may extend between the upper 34 and lower 66 wafers in order to couple the wafers together, including portions of the upper 34 or lower 66 wafers themselves.

The lower wafer 66 may be a silicon-on-insulator wafer having a silicon layer 67 and an insulating layer 69. The lower wafer 66 can also be a standard silicon wafer, or can be made of a variety of semiconducting materials beyond silicon, such as GaAs or InP. The lower wafer 66 may include a plurality of electrodes or conductive surfaces 70, 72, 74, 76 located on an upper surface 75 of the lower wafer 66. The electrodes 70, 72, 74, 76 can be activated (such as by applying a voltage to the electrodes) to control movement of the movable portions 32 and associated reflective surfaces 31. As shown in FIGS. 3-5, each mirror 30 preferably includes an associated set of electrodes 70, 72, 74, 76. The set of electrodes 70, 72, 74, 76 located below each mirror 30 preferably includes a pair of actuating electrodes 70, 72 and a pair of adjustment electrodes 74, 76 located below each mirror 30 and movable portion 32.

As shown in FIGS. 6 and 7, the lower wafer 66 further preferably includes control electronics (generally designated 80) for controlling the actuation of the electrodes 70, 72, 74, 76. The control electronics 80 preferably include a plurality of complementary metal-oxide semiconductor transistors (“CMOS”) 82 spaced away from a top or outer surface of the lower wafer 66 and located at least partially in the silicon layer 67. The CMOS 82 may also be located at least partially in the insulating layer 69 of the lower wafer 66. The control electronics 80 may also include a plurality of transistors (not shown). In this arrangement, the CMOS 82 provide the logic circuitry for controlling the application of voltages to the electrodes 70, 72, 74, 76, and the transistors route the applied voltages in a manner “directed” or controlled by the CMOS 82. Of course, the control electronics 80 may include nearly any electronic component(s) that can provide the logic and routing circuitry for directing the desired voltages to the electrodes 70, 72, 74, 76 in the desired manner. However, CMOS may be preferred as the logic circuitry and as a high voltage driver because CMOS uses relatively low amounts of power and therefore generates relatively little heat. The CMOS 82 or other logic circuitry is preferably coupled together in a multiplexed fashion. The CMOS 82 is preferably coupled to an output pad 88 or output pads that preferably extend around the outer perimeter of the lower wafer 66 (see FIG. 5). In this manner, a controller, processor, computer, CPU or the like can be coupled to the control electronics 80 by coupling the controller, processor, computer or CPU to the output pad(s) 88.

In order to operate the mirror array 10 of FIGS. 2-7, a controller, processor, computer or CPU or the like is connected to the output pads 88 of the control electronics 80. The controller can then provide signals to the control electronics 80 to apply various voltages in the desired manner to the desired electrodes 70, 72, 74, 76. For example, as best shown in FIG. 6, a positive or negative AC or DC voltage may be applied to the actuating electrode 72. The voltage applied to all of the electrodes 72 of the array 10 can be any applied voltage to achieve the desired rotation, for example, about 200 volts. The voltages in the actuating electrode 72 creates an electrostatic force that causes the conductive movable portion 32 to rotate in the direction of arrow C (i.e., about axis A and about inner arms 44, 46 (see FIGS. 4 and 8)). As the movable portion 32 is rotated or tilted, the reflective surface 31 located thereon is also thereby tilted to the desired configuration. The degree of rotation of the movable portion 32 can be controlled by the voltages applied to the electrode 72. In this manner each mirror 30 can reflect an incoming light signal in the desired direction.

When the movable portion 32 and reflective surface 31 are rotated about axis A, the inner arms 44, 46 are twisted or placed in a state of tension/compression. Thus, when the voltage applied to the actuating electrode 72 is removed or sufficiently reduced, the movable portion 32 and mirror 30 rotate in the direction opposite to arrow C to return the movable portion 32 to its neutral position shown in FIG. 6. In this manner, the spring force of the inner arms 44, 46 returns the movable portion 32 and mirror 30 to their neutral position. Thus, the forces applied by the electric field of the actuating electrode 72 must overcome the spring force of the arms 44, 46 in order to cause rotation of the associate movable portion 32. Of course, the movable portion 32 can be moved in the direction opposite to arrow C by applying a voltage to electrode 70.

The adjustment electrodes 74, 76 can be used to ensure that the movable portion 32 rotates in the desired plane. In other words, a voltage can be applied to the adjustment electrodes 74, 76 to set up an electrical field that can cause the movable portion to rotate about the outer arms 52, 54 (about axis B of FIG. 4) and in the directions of arrow D (FIG. 7). Thus, the adjustment electrodes 74, 76 can provide adjustments to ensure that the movable portion 32 rotates smoothly about axis B. Alternately, the adjustment electrodes 74, 76 may be used to provide another degree of freedom to the movement of the movable portions 32.

In this manner, the controller, with assistance from the control electronics 80, can simultaneously execute control over each set of electrodes 70, 72, 74, 76 associated with each movable portion 32 and mirror 30 to simultaneously control the movement of each mirror 30.

The array 10 can thereby be controlled by the controller to reflect a large number of beams of light signals to carry out the switching function of the mirror array 10.

The bond between the upper 34 and lower 66 wafers is preferably conductive so that the control electronics 80 can control the voltages of the mirrors 30. In particular, the control electronics 80 may be electrically coupled to the posts 68, and the posts 68 may be electrically coupled to the upper layer 62 of the upper wafer 34. In this manner the voltage of the upper layer 62 of the upper wafer 34 can be controlled so that the voltage differential between the electrodes 70, 72 and the mirrors 30 are precisely controlled. The voltage of the upper layer 62 is preferably maintained at ground. Instead of contacting the upper layer 62 via the posts 68, the control electronics 80 can be electrically coupled to the upper layer 62 by a variety of other methods, such as wires and wire bonds

In one embodiment, each of the arms 44, 46, 52, 54 may each include a piezoresistor located thereon (not shown) which can provide feedback to the controller such that the controller can track the rotational position of the movable portions 32 and mirrors 30. The piezoresistors may be coupled to the output pads 88 for connection to the controller. The piezoresistive sensors in the arms 44, 46, 52, 54 may be calibrated during the final stages of assembly or by the end user.

As shown in FIG. 8, in one embodiment the upper wafer 34 may include a set of legs or standoffs 92 located at its top surface. The legs 92 may be used to provide stiffness to the array 10. The legs 92 also extend upwardly from the main body of the lower wafer 34 so that the legs 92 can engage an adhesive surface during dicing of the array 10. For example, in order to dice the array 10, the array may be inverted from its orientation shown in FIG. 8 and placed on a flat surface. When the array is located on the flat surface, the legs 92 engage the flat surface and space the mirrors 30 away from the flat surface. In this manner the legs 92 protect the mirror 30 surfaces during dicing.

As noted earlier, the lower wafer 66 preferably includes the electrodes 70, 72, 74, 76 as well as the CMOS 82 and other control electronics 80. The control electronics 80 may be located below the upper surface 75 of the lower wafer 66 and adjacent to the intersection of layers 66, 69. In this manner, the control electronics 80 are located below, and on the same wafer as, the electrodes 70, 72, 74, 76 to provide significant space savings, which increases mirror packaging density and reduces costs. As will be discussed in greater detail below, the control electronics 80 can also be pre-fabricated on the lower wafer 66 by an integrated circuit wafer manufacturer. Once the pre-fabricated wafer is received by the mirror array manufacturer, the electrodes 70, 72, 74, 76 can be formed on the lower wafer 66. Alternately, the control electrodes 80 can also be formed on the lower wafer 66 by the integrated circuit manufacturer. The upper wafer 34 can then be manufactured and coupled to the lower wafer 66. In this manner, all of the connections between electrodes 70, 72, 74, 76 and the control electronics 80 can be easily accomplished, or are accomplished during manufacturing of the lower wafer 66.

Furthermore, by integrating the control electronics 80 on the lower wafer 66, the signals to and from the controller can be processed and multiplexed on the lower wafer 66. In this manner, the electrical connections to and from the electrodes 70, 72, 74, 76 can be formed as a part of the lower wafer 66, which reduces the need to make connection between electrodes 70, 72, 74, 76 during assembly of the mirror array 10.

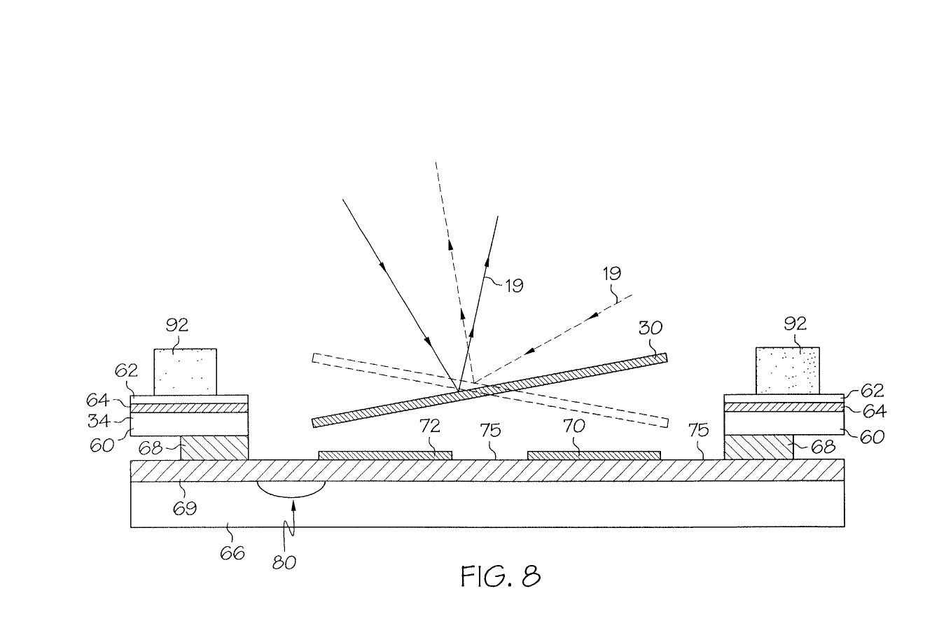

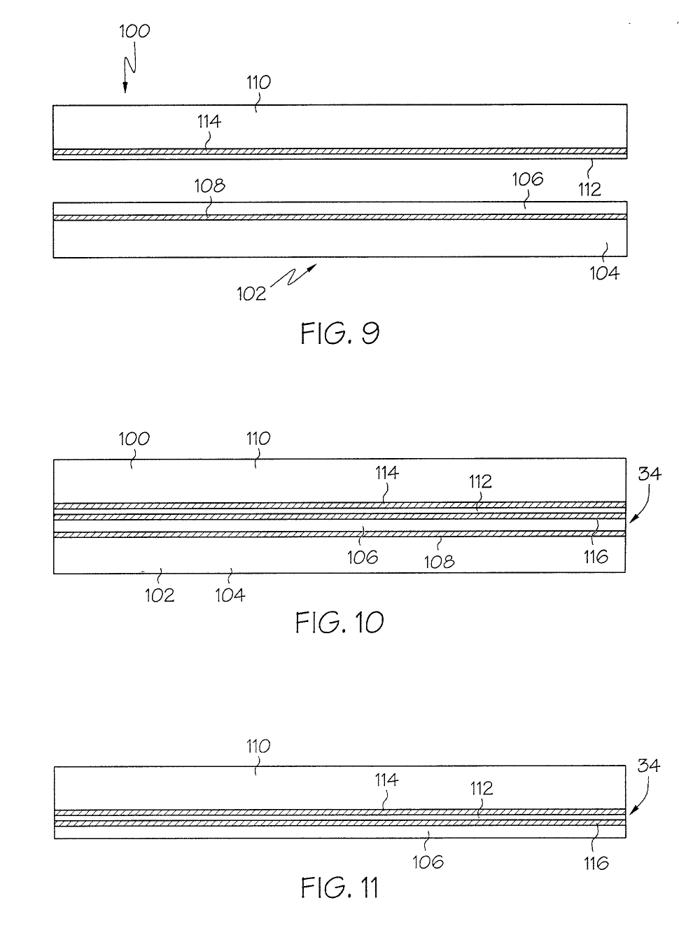

FIGS. 9-26 illustrate various methods for forming the mirror array 10 of FIGS. 2-8, although various other methods of forming the mirror array 10 may be used without departing from the scope of the invention. The array 10 is preferably batch processed such that a plurality of movable portions, reflective surfaces, mirrors, electrodes, control electronics and the like are simultaneously formed on a wafer or wafers. However, for ease of illustration, FIGS. 9-26 illustrate only a single mirror and the associated components being formed.

FIGS. 9-26 are representative cross-sections which are intended to illustrate various features of the manufacturing process, and may not identically represent a cross-section of the device. Furthermore, the manufacturing steps illustrated hereon are only one manner in which the mirror array 10 of the present invention may be manufactured, and the order and details of each step described herein may vary, or other steps may be used or substituted with other steps well known in the art.

As shown in FIG. 9, in one embodiment the process begins with a mirror wafer 100 and a cavity wafer 102. Both the mirror wafer 100 and cavity wafer 102 are preferably silicon-on-insulator wafers. In one embodiment, the cavity wafer 102 includes a lower silicon layer 104 having a thickness of about 400 microns and upper silicon layer or support layer 106 having a thickness of about 40 microns (the relative thicknesses of the various layers are not shown in scale in the accompanying drawings). An insulating layer 108 is located between the upper 106 and lower 104 silicon layers. The insulating layer 108 (as well as the other insulating layers discussed herein) may be a silicon dioxide layer having a thickness of about 1 micron, but could also be nearly any insulating or dielectric layer.

The mirror wafer 100 may be a silicon-on-insulator wafer including an upper silicon layer 110 having a thickness of about 400 microns, a lower silicon layer 112 having a thickness of about 2 microns, and a thin insulating layer 114 located between upper 110 and lower 112 silicon layers. The upper and lower silicon layers of both the mirror 100 and cavity 102 wafers, and particularly the lower layer 112 of the mirror wafer 100, are preferably made of doped silicon such that the lower layer 112 has a relatively high electrical conductivity. However, the mirror 100 and cavity 102 wafers can also be made from a variety of other materials besides silicon, such as amorphous silicon, polysilicon, silicon carbide, germanium, polyimid, ceramics, nitride, sapphire, silicon nitride, glasses, a combination of these materials or nearly any other machinable material. However, as noted above, the lower layer 112 of the mirror wafer 100, from which the movable portions 32 will ultimately be formed, is preferably electrically conductive, and has the desired thickness of the movable portions 32 and associated arms 44, 46, 52, 54.

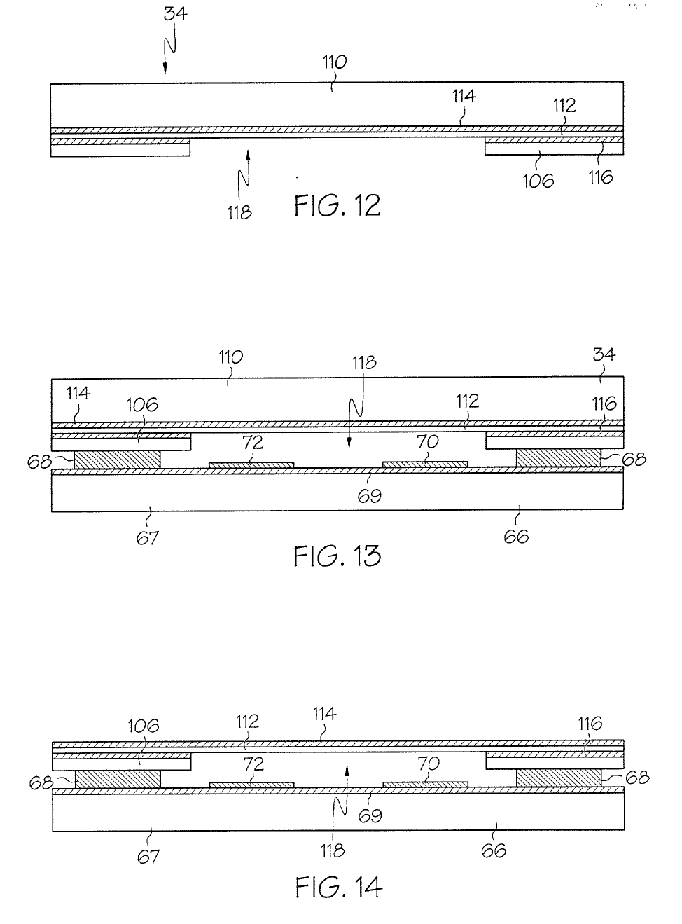

As shown in FIG. 10, an insulating layer 116 is formed on one or both of the mirror wafer 100 and cavity wafer 102, and the mirror wafer 100 and the cavity wafer 102 are joined together. A wide variety of joining methods, such as bonding, may be used. The mirror wafer 100 and cavity wafer 102, when bonded together, together form the upper wafer 34. Next, as shown in FIG. 11, the lower silicon layer 104 and the insulating layer 108 of the cavity wafer 102 are removed. Various methods may be used to remove the lower layer 104 and insulating layer 108 such as wet etching, dry etching, deep reactive ion etching (“DRIE”) and the like. Next, as shown in FIG. 12, a cavity 118 is formed in the upper silicon layer 106 and insulating layer 116 of the cavity wafer 102. The cavity 118 exposes the lower layer 112 of the mirror wafer 110 to expose what will ultimately be the movable portion 32 (i.e., the mirror receiving surface). The cavity 118 may be formed by a variety of etching methods, such as wet etching, dry etching DRIE and the like.

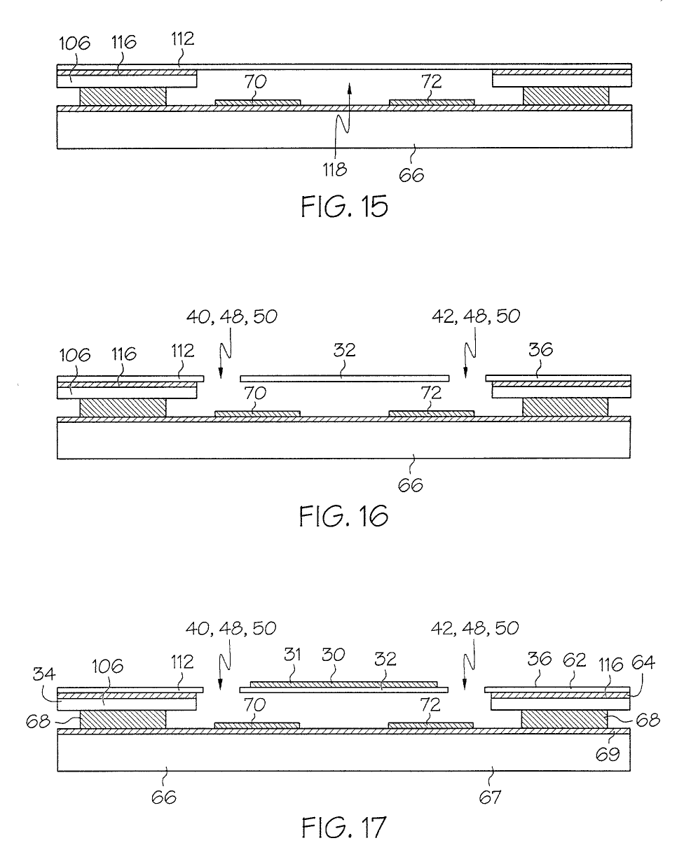

Next, as shown in FIG. 13, a lower wafer 66 is provided and bonded to the upper wafer 34. The lower wafer 66 preferably includes a layer of silicon 67 and insulating layer 69 located thereon. As noted earlier, the lower wafer 66 is preferably manufactured such that the control electronics (not shown in FIG. 13) are located therein. The lower wafer 66 is preferably manufactured (such as by a wafer manufacturer using standard wafer manufacturing techniques) such that the control electronics are manufactured according to the desired specifications for the size and location of the electrodes 70, 72, configuration of the CMOS 82 and the like. As indicated earlier, the upper wafer 34 can be bonded to the lower wafer 66 by a variety of methods, preferably by eutectic bonding or thermo compression bonding, such as glass frit bonding. Next, as shown in FIG. 14, the upper silicon layer 110 of the mirror wafer 100 is removed, preferably by DRIE etching. The insulating layer 114 of the mirror wafer 100 is then removed, preferably by RIE or wet etching (see FIG. 15).

As shown in FIG. 16, the mirror receiving surface 112 (i.e., the lower silicon layer 112 of the mirror wafer 100) is then etched to form the base portion 36 and movable portions 32 of the array. More particularly, the cut outs 40, 42, 48, 50 are formed in the lower silicon layer 112 of the mirror wafer 100 to form the intermediate portion 58 and inner 44, 46 and outer 52, 54 arms (not shown in FIG. 16). Because high precision is required during this etching process, the etching is preferably accomplished using DRIE.

Finally, as shown in FIG. 17, the reflective material 31, such as gold or another metal, is deposited on the movable portion 32 to form the mirror 30 thereon. The metal is preferably deposited by sputtering a metal through a shadow mask and onto the movable portion 32. Nearly any metal which can reflect the desired wavelength of energy may be used as the reflective material 31. It has been found that gold is an appropriate material that may be used to reflect infrared radiation. The reflective material 31 preferably has a reflectivity of greater than about 95% at infrared wavelengths.

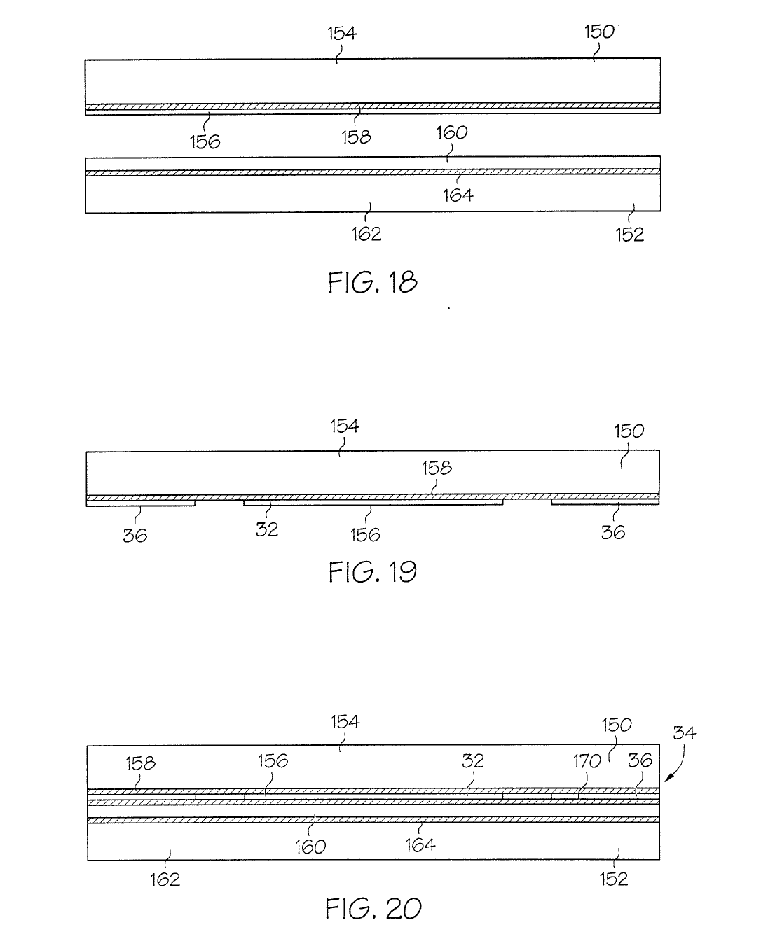

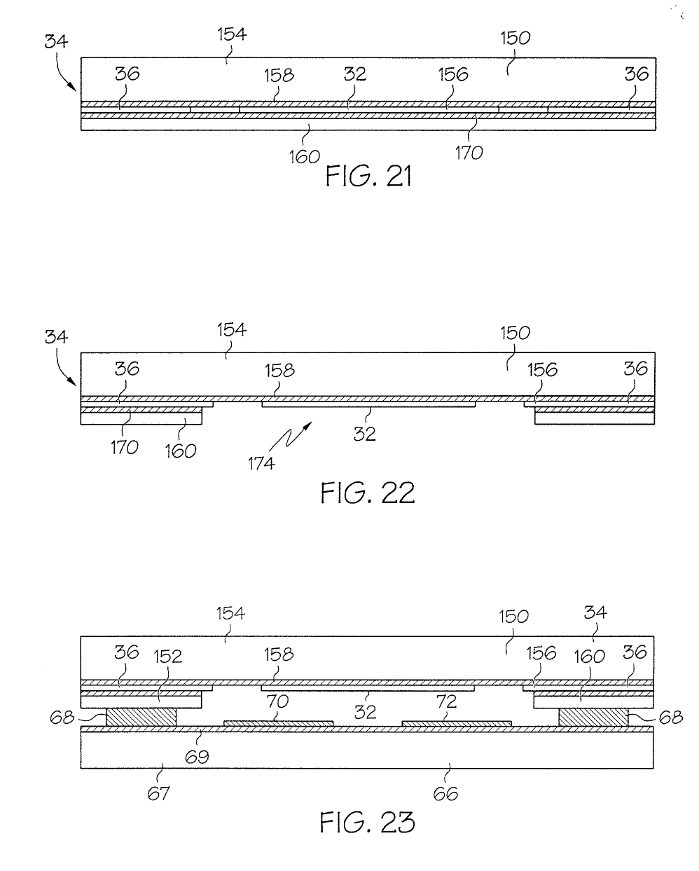

FIGS. 18-26 illustrate an alternate method for forming the array 10 of the present invention. As shown in FIG. 18, the process begins with the mirror wafer 150 and cavity wafer 152 in the same manner as described above in the context of FIG. 9. The mirror wafer 150 includes an upper silicon layer 154, a lower silicon layer 156 and an insulating layer 158, and the cavity wafer 152 includes an upper silicon layer 160, a lower silicon layer 162 and an insulating layer 164. As shown in FIG. 19, the lower layer 156 of the mirror wafer 150 is etched to form the base portion 36 and movable portion 32. The base portion 36 and movable portion 32 are defined by forming the cut outs 40, 42, 48, 50 (not shown in FIG. 19) in the mirror receiving surface 156 to form the inner arms 44, 46, outer arms 52, 54 and intermediate portion 58 (not shown in FIG. 19). Next, as shown in FIG. 20, an insulating layer 170 is grown or deposited on the cavity wafer 152, and the mirror wafer 150 and the cavity wafer 152 are joined together in the same manner described in the context of FIG. 10. Next, the lower silicon layer 152 and insulating layer 164 of the cavity wafer 152 are removed or etched away, as shown in FIG. 21, to reduce the final thickness of the mirror array. Next, as shown in FIG. 22, the upper silicon layer 160 and insulating layer 170 of the cavity wafer 152 are etched or partially removed to form a cavity 174 and expose the movable portion 32.

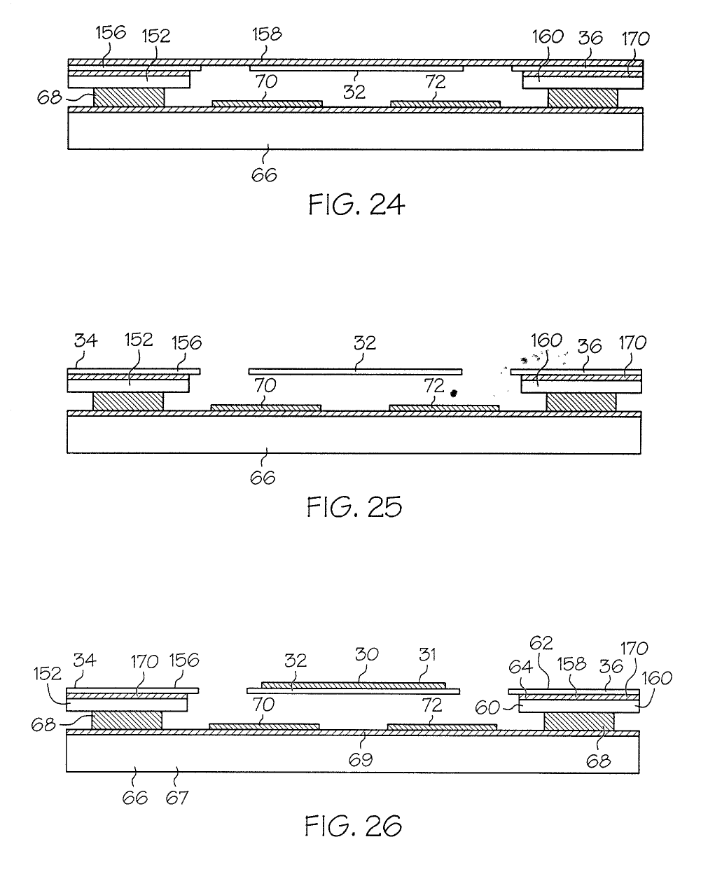

The lower wafer 66 is then provided and coupled to the upper wafer 34 in the same manner described above in the context of FIG. 13. Next, as shown in FIG. 24, the upper silicon layer 154 of the mirror wafer 150 is removed in the same manner as described in the context of FIG. 14. As shown in FIG. 25, the insulating layer 158 of the mirror wafer 150 is removed, such as by RIE to release the movable portion 32. Finally, as shown in FIG. 26, the reflective material 31 is sputtered onto the movable portion 32 in the same manner as described above in the context of FIG. 17 to form the mirror 30.

The manufacturing process of FIGS. 9-17 may be advantageous because the arms 44, 46, 52, 54, intermediate surface 58, cut outs 40, 42, 48, 50 and other components of the mirror receiving surface are etched after the upper silicon layer 110 and oxide layer 114 have been removed. In this manner, any stresses of the adjacent layers 110, 114 (i.e., inherent thermal stresses in the mirror wafer 100) are not transmitted to the etched surfaces of the layer 112. This results in a more accurate, precise mirror array 10.

The manufacturing process of FIGS. 18-26 may be advantageous because processing steps wherein the thin layer of silicon 156, 62 (i.e., the mirror receiving surface) is exposed is minimized, which may provide a higher yield of arrays.

As can be seen from the manufacturing process as described above, the lower wafer 66 and upper wafer 34 are each at least partially premanufactured before they are joined together. This provides greater flexibility in manufacturing the mirror array 10 and raises the overall yield of the arrays. For example, a number of upper 34 and lower 66 wafers can be premanufactured according to varying specifications, and the premanufactured upper 34 and lower 66 wafers can then be stored. When an order for an array 10 is received from a customer, the upper 34 and lower 66 wafers then correspond to the parameters of the desired array can then be obtained, joined together and processed to completion. Furthermore, premanufacturing the wafers 34, 66 enables any faulty upper or lower wafers to be detected and disposed of before they are coupled together which thereby increases the overall yield of the array manufacturing process.

As noted above, the lower wafer 66 is preferably premanufactured by a wafer chip manufacturer with the control electronics 80 integrated therein. The electrodes 70, 72, 74, 76 may also be formed on the lower wafer 66 by the wafer chip manufacturer. Alternately, if the electrodes 70, 72, 74, 76 are not formed on the lower wafer 66 by the wafer chip manufacturer, the wafer chip manufacturer may implant the control electronics 80 in the lower wafer 66 such that the control electronics 80 include leads that extend up to the upper surface 75 of the lower wafer 66. In this manner the array manufacturer can deposit the electrodes 70, 72, 74, 76 on the upper surface 75 of the lower wafer 66 such that the electrodes 70, 72, 74, 76 are electrically coupled to the leads of the control electronics 80.

In this manner, the electrodes 70, 72, 74, 76 can be easily coupled to the control electronics 80 without the need for any wire bonding. The only wire bonds that will be required is the bonds from the controller to the output pads 88 of the lower wafer 66. Furthermore, because the control electronics 80 are located below the electrodes 70, 72, 74, 76, the lower wafer 66 is relatively compact.

Having described the invention in detail and by reference to the preferred embodiments, it will be apparent that modifications and variations thereof are possible without departing from the scope of the invention.

What is claimed is:

1. A micro mirror array comprising:
an upper wafer including a plurality of movable reflective surfaces located thereon; and
a lower wafer located below and coupled to said upper wafer, said lower wafer having an upper surface including a plurality of electrodes located thereon for controlling the movement of said movable reflective surfaces when a voltage is applied thereto, said lower wafer including control electronics generally spaced away from said upper surface and coupled to said electrodes for controlling the voltages applied to said electrodes.

2. The array of claim 1 wherein said upper wafer includes a silicon layer, and wherein said reflective surface are located on said silicon layer.

3. The array of claim 1 wherein said upper wafer includes a base portion and a plurality of movable portions rotatably coupled to base portion, and wherein each reflective surface is located on one of said movable portions.

4. The array of claim 3 wherein each movable portion is coupled to said base portion by at least one arm, and wherein said at least one arm includes a sensor located thereon such that said sensor can sense rotation of said movable portion relative to said base portion.

5. The array of claim 4 wherein each sensor is a piezoresistor.

6. The array of claim 1 wherein said upper wafer includes at least a portion of at least one silicon-on-insulator wafer.

7. The array of claim 1 wherein each reflective surface is independently movable about two generally perpendicular axes.

8. The array of claim 1 wherein said upper wafer is eutectic bonded or thermo compression bonded to said lower wafer.

9. The array of claim 1 wherein each reflective surface is located on a conductive movable portion such that a voltage can be applied to an associated electrode to cause movement of the associated movable portion and reflective surface.

10. The array of claim 9 wherein each electrode is located below an associated movable portion and wherein said lower wafer includes a plurality of output pads electrically coupled to said control electronics and located adjacent an outer perimeter of said lower wafer.

11. The array of claim 10 further comprising a controller coupled to said plurality of output pads to control the voltages applied to said electrodes by said control electronics to thereby control the movement of said plurality of reflective surfaces.

12. The array of claim 1 wherein at least two electrodes are located below each of said reflective surfaces such that a voltage can be applied to said electrodes to cause the associated reflective surfaces to move in at least two directions.

13. The array of claim 1 wherein at least four electrodes are located below each of said reflective surfaces such that a voltage can be applied to either of a first two of said set of four electrodes to cause the associated reflective surface to rotate about a first axis, and such that a voltage can be applied to either of the other two of said set of four electrodes to cause said reflective surface to rotate about a second axis.

14. The array of claim 1 wherein said control electronics includes CMOS logic circuitry.

15. The array of claim 1 wherein said lower wafer is a silicon wafer including a silicon layer and a insulating layer located thereon, and wherein said control electronics are located below said upper surface and adjacent to the junction between said silicon layer and said insulating layer.

16. The array of claim 1 wherein said upper wafer includes a plurality of generally upwardly extending legs that extend upwardly beyond said plurality of reflective surfaces.

17. A micro mirror array comprising:
an upper wafer including a base portion and a plurality of movable portions rotatably coupled to said base portion, each of said movable portions having a reflective surface located thereon; and
a lower wafer located below and coupled to said upper wafer, said lower wafer including a plurality of electrodes, each electrode being located adjacent to one of said movable portions such that a voltage can be applied to said electrodes to cause an associated one of the movable portions to move, said lower wafer including control electronics integrated therein and electrically coupled to said electrodes.

18. A method for manufacturing a micro mirror array comprising the steps of:
providing an upper wafer including a support layer and a mirror-receiving surface located over said support layer;
providing a lower wafer including a plurality of electrodes and control electronics coupled to said electrodes for controlling a voltage applied to said electrodes;
coupling said upper wafer to said lower wafer;
removing said support layer to expose said mirror-receiving surface; and
depositing a reflective material on said mirror-receiving surface to form a plurality of mirrors, each mirror being located above an associated electrode on said lower wafer.

19. The method of claim 18 wherein said coupling step includes eutectic bonding or thermo compression bonding.

20. The method of claim 18 further comprising the step of etching through said mirror-receiving surface to define a base portion and a plurality of a movable portions coupled to said base portion, each movable portion having a portion of said reflective material located thereon.

21. The method of claim 18 wherein said first providing step includes providing a cavity wafer and a mirror wafer, and coupling said cavity wafer and said mirror wafers together to form said upper wafer.

22. The method of claim 21 wherein said cavity wafer and said mirror wafers are both silicon-on-insulator wafers, and wherein said first providing step further includes the step of, before coupling said cavity wafer and said mirror wafer together, etching a lower silicon layer of said mirror wafer to define a base portion and a plurality of movable portions coupled to said base portion.

23. The method of claim 22 wherein said etching of said movable portions includes etching said mirror wafer such that each movable portion is coupled to said base portion by at least one arm.

24. The method of claim 23 wherein said first providing step further includes, after coupling said cavity wafer and mirror wafer together, removing a lower silicon layer and insulating layer of said cavity wafer.

25. The method of claim 24 wherein said first providing step further includes etching a plurality of cavities in said cavity wafer to expose each of said movable portions.

26. The method of claim 25 further comprising the step of, after said coupling step, removing an upper silicon layer of said mirror wafer to expose an insulating layer of said mirror wafer.

27. The method of claim 26 further comprising the step of removing said insulating layer of said mirror wafer to expose said movable portions.

28. The method of claim 27 further comprising the step of depositing a reflective surface on each of said movable portions to form a plurality of mirrors.

29. The method of claim 21 wherein said cavity wafer and said mirror wafer are both silicon-on-insulator wafers, and wherein the first providing step further includes removing a lower silicon layer and an insulating layer of said cavity wafer after said cavity wafer and said mirror wafer are coupled together.

30. The method of claim 29 wherein said first providing step includes etching said cavity wafer to form a plurality of cavities therein, each cavity exposing a lower silicon layer of said mirror wafer.

31. The method of claim 30 further comprising the step of, after said coupling step, removing an upper silicon layer and an insulating layer of said mirror wafer to expose said lower silicon layer of said mirror wafer.

32. The method of claim 31 further comprising the step of etching said lower silicon layer of said mirror wafer to form a base portion and a plurality of movable portions coupled to said base portion.

33. The method of claim 32 wherein said etching of said movable portions includes etching said movable portions such that each movable portion is movably coupled to said base portion by at least one arm.

34. The method of claim 33 further comprising the step of depositing a reflective surface on each of said movable portions to form a plurality of mirrors.

35. The method of claim 18 wherein said second providing step includes providing a lower wafer having an upper surface with said electrodes located thereon, and wherein said control electronics are located generally below said upper surface.

36. A method for manufacturing a micro mirror array comprising the steps of:
providing an upper wafer including a mirror-receiving surface;
providing a lower wafer including a plurality of electrodes and control electronics coupled to said electrodes for controlling a voltage applied to said electrodes;
coupling said upper wafer to said lower wafer; and
etching said mirror-receiving surface to form a base portion and a plurality of movable portions coupled to said base portion, and wherein each movable portion is located over one of said electrodes.

37. A micro mirror array comprising:
a wafer including a base and a plurality of movable portions, each movable portion having a reflective surface located thereon and being coupled to said base by at least one arm such that each movable portion can rotate about the associated at least one arm, each arm having a piezoresistor located thereon to detect any rotation of the associated movable portion relative to said base; and
a plurality of electrodes located adjacent to said reflective surfaces for controlling the movement of said movable reflective surfaces when a voltage is applied to said electrodes

38. The array of claim 37 wherein each movable portion is coupled to said base by a pair of arm located on opposed sides of said mirror, and wherein each arm includes a pizeoresistor location thereon to detect any rotation of the associated movable portion relative to said base.
